(19) United States
(12) Patent Application Publication
(10) Pub. No.: US 2017/0357240 A1
(43) Pub. Date: Dec. 14, 2017

(54) SYSTEM AND METHOD SUPPORTING EXPLORATORY ANALYTICS FOR KEY PERFORMANCE INDICATOR (KPI) ANALYSIS IN INDUSTRIAL PROCESS CONTROL AND AUTOMATION SYSTEMS OR OTHER SYSTEMS

(71) Applicant: Honeywell International Inc., Morris Plains, NJ (US)

(72) Inventors: Gregory E. Stewart, North Vancouver (CA); David J. Germann, North Vancouver (CA)

(21) Appl. No.: 15/180,950

(22) Filed: Jun. 13, 2016

(51) Int. Cl. G05B 19/406

(52) U.S. Cl. CPC G05B 19/406; G05B 2219/31368; G05B 2219/31229

(57) ABSTRACT

A method includes receiving information associated with industrial equipment from multiple data sources. The information includes different types of information related to the industrial equipment and is received from at least two different types of data sources. The method also includes executing exploratory analysis routines using at least some of the received information and generating one or more displays identifying results of the exploratory analysis routines. At least one of the exploratory analysis routines uses key performance indicator (KPI) data associated with the industrial equipment. At least one of the exploratory analysis routines includes logic defined by at least one user associated with the industrial equipment and uses data that is retrieved based on input from the at least one user.

### TECHNICAL FIELD

This disclosure relates generally to industrial process control and automation systems. More specifically, this disclosure relates to a system and method supporting exploratory analytics for key performance indicator (KPI) analysis, which could be used to solve fundamental but challenging problems for users of industrial process control and automation systems or other systems.

### BACKGROUND

Industrial process control and automation systems are routinely formed using a large number of devices, such as sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. The components in a control and automation system can generate large amounts of data over time. The data has often been used in the past only to perform simpler functions, such as to perform loop tuning in which process control loops in a control and automation system are adjusted.

### SUMMARY

This disclosure provides a system and method supporting exploratory analytics for key performance indicator (KPI) analysis in industrial process control and automation systems or other systems.

In a first embodiment, a method includes receiving information associated with industrial equipment from multiple data sources. The information includes different types of information related to the industrial equipment and is received from at least two different types of data sources. The method also includes executing exploratory analysis routines using at least some of the received information. The method further includes generating one or more displays identifying results of the exploratory analysis routines. At least one of the exploratory analysis routines uses KPI data associated with the industrial equipment. At least one of the exploratory analysis routines includes logic defined by at least one user associated with the industrial equipment and uses data that is retrieved based on input from the at least one user.

In a second embodiment, a system includes at least one interface configured to receive information associated with industrial equipment from multiple data sources. The information includes different types of information related to the industrial equipment and is received from at least two different types of data sources. The system also includes at least one processing device configured to execute exploratory analysis routines using at least some of the received information and generate one or more displays identifying results of the exploratory analysis routines. At least one of the exploratory analysis routines uses KPI data associated with the industrial equipment. At least one of the exploratory analysis routines includes logic defined by at least one user associated with the industrial equipment and uses data that is retrieved based on input from the at least one user.

In a third embodiment, a non-transitory computer readable medium contains computer readable program code that when executed causes at least one processing device to receive information associated with industrial equipment from multiple data sources. The information includes different types of information related to the industrial equipment and is received from at least two different types of data sources. The medium also contains computer readable program code that when executed causes the at least one processing device to execute exploratory analysis routines using at least some of the received information and generate one or more displays identifying results of the exploratory analysis routines. At least one of the exploratory analysis routines uses KPI data associated with the industrial equipment. At least one of the exploratory analysis routines includes logic defined by at least one user associated with the industrial equipment and uses data that is retrieved based on input from the at least one user.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting exploratory analytics for key performance indicator (KPI) analysis according to this disclosure;

FIG. 2 illustrates an example device supporting exploratory analytics for KPI analysis according to this disclosure;

FIG. 3 illustrates an example technique supporting exploratory analytics for KPI analysis according to this disclosure;

FIGS. 4 through 11 illustrate example graphical displays based on exploratory analytics for KPI analysis according to this disclosure; and

FIG. 12 illustrates an example method supporting exploratory analytics for KPI analysis according to this disclosure.

### DETAILED DESCRIPTION

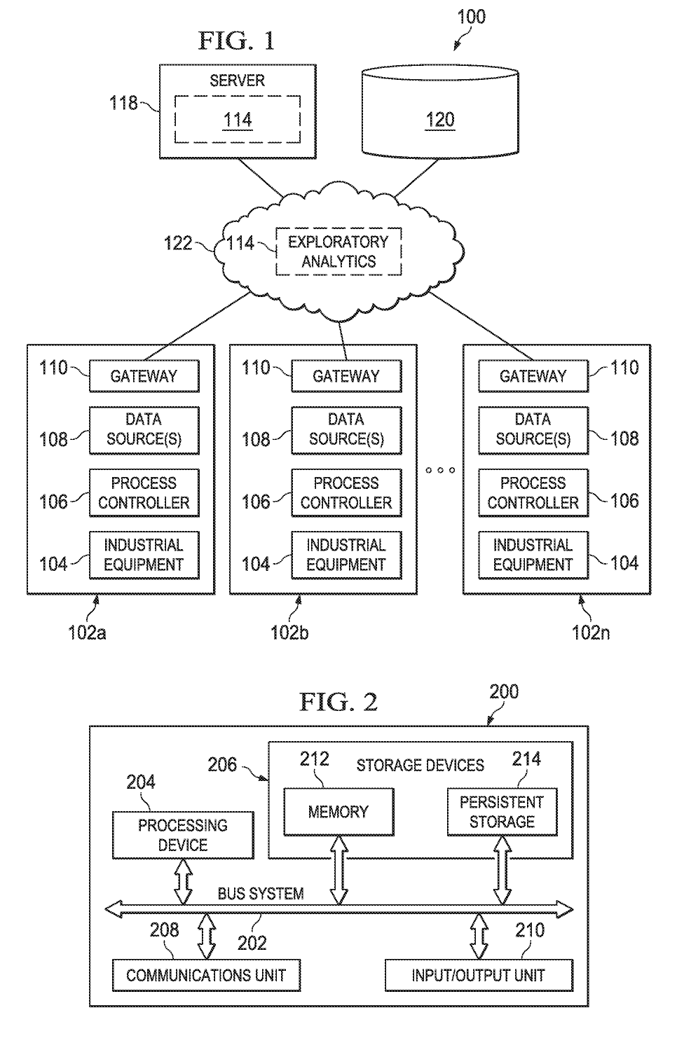

FIGS. 1 through 12, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 supporting exploratory analytics for key performance indicator (KPI) analysis according to this disclosure. As shown in FIG. 1, the system 100 includes one or multiple sites 102a-102n. Each site 102a-102n generally denotes a location at which one or more industrial processes are implemented using industrial equipment 104. Different sites 102a-102n could denote different areas or zones within a single larger site or different areas or zones that are separated by small or large distances. Note that different areas or zones do not require physical separation but merely logical separation of industrial equipment 104, so equipment 104 that is side-by-side could be identified within different sites. Also, all sites 102a-102n could be associated with the same organization (such as a national or multi-national corporation), or different sites 102a-102n could be associated with different organizations (such as small or large national or multi-national corporations).

The industrial equipment 104 at each site 102a-102n represents any suitable industrial equipment whose operation can be monitored or controlled. The industrial equipment 104 could be used to implement any suitable industrial process or processes. For example, the industrial equipment 104 could include equipment used to manufacture or process one or more chemical, pharmaceutical, paper, or petrochemical products. As specific examples, the industrial equipment 104 could include machines with rotating components (such as compressors, pumps, turbines, motors, or engines), heat transfer equipment (such as heat exchangers, heaters, or boilers), or general process equipment (such as reactors, vessels, and columns). In general, the industrial equipment 104 includes any suitable industrial equipment at one or multiple sites.

Each site 102a-102n also includes one or more industrial process controllers 106, which are used to control the operations of the industrial equipment 104. Often times, process controllers 106 are arranged hierarchically at a site 102a-102n, with different levels performing different functions. For example, a lower-level controller 106 may use measurements from one or more sensors to control the operations of one or more actuators in order to monitor and adjust the overall operation of the industrial equipment 104. A higher-level controller 106 could perform planning, scheduling, or optimization functions to adjust the operation of the lower-level controller 106.

Each controller 106 includes any suitable structure for controlling at least one aspect of an industrial site. A controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system, a WINDOWS operating system, or other operating system.

Each site 102a-102n further includes one or more data sources 108. Each data source 108 could represent a component that stores various information about or related to a site 102a-102n. For example, one or more data sources 108 at each site 102a-102n could denote at least one process historian used to store information collected or generated by the process controllers 106, sensors, actuators, or other components at the site 102a-102n. One example type of process historian is the PROCESS HISTORY DATABASE (PHD) product from HONEYWELL INTERNATIONAL INC. One or more data sources 108 at each site 102a-102n could also denote at least one operations management system used to store information about what different personnel were doing at the site 102a-102n, such as information defining different work shifts at the site 102a-102n or comments provided at different times by personnel at the site 102a-102n. One example type of operations management system is the OPERATIONS MANAGEMENT PRO (OMPro) product from HONEYWELL INTERNATIONAL INC. One or more data sources 108 at each site 102a-102n could further denote at least one alarm management system that collects, manages, and tracks alarms and other notifications related to the process equipment 104 at that site 102a-102n. One example type of alarm management system is the DYNAMO product from HONEYWELL INTERNATIONAL INC. Any other or additional type(s) of information suitable for use in exploratory analytics for KPI analysis could be used in the system 100, such as maintenance logs or other maintenance system records.

The type(s) and amount(s) of information stored by the data sources 108 could vary in numerous ways, such as from site to site or from organization to organization. In some cases, a data source 108 could be used to store months or even years of data related to operation of an industrial site 102a-102n. Each data source 108 represents any suitable structure for storing and facilitating retrieval of information.

In addition, each site 102a-102n includes one or more gateways 110. Each gateway 110 allows data transfers to or from a site 102a-102n. For example, a gateway 110 may allow the data source(s) 108 at a particular site 102a-102n to be accessed remotely so that data from the data source(s) 108 can be retrieved. Each gateway 110 could support any other or additional operations, depending on the implementation and the site 102a-102n at which the gateway 110 is used. Each gateway 110 includes any suitable structure supporting communication with an industrial site.

While not shown, one or more networks can be used to support communications between various components within each site 102a-102n. For example, one or more proprietary or standard control networks could couple one or more process controllers 106 to industrial equipment 104. Also, one or more proprietary or standard data networks could couple one or more process controllers 106, data sources 108, and gateways 110 together. In particular embodiments, each site 102a-102n could be arranged according to the “Purdue” model of process control.

As noted above, components in a control and automation system can generate large amounts of data over time. The data has often been used in the past only to perform simpler functions, such as to perform loop tuning in which process control loops in a control and automation system are adjusted. There are often fundamental questions that owners or operators of one or more industrial facilities have, but there has been no way to effectively answer those questions with conventional systems. For example, the owner or operator of an industrial facility may wish to know whether there are any common contributors (such as product, work shift, or raw material) to periods of high or low product quality. As another example, the owner or operator of an industrial facility may wish to know the average product quality for production runs of a specified product when a specified work shift was on duty and when a specified raw material from a specified vendor was being used. As a third example, the owner or operator of an industrial facility may wish to know whether there is some type of relationship between different variables associated with an industrial process. As a fourth example, the owner or operator of an industrial facility or multiple industrial facilities may wish to view overall profitability of the facility or facilities and then “drill down” to view details about specific sites or specific plants at a site. The details could include factors such as products being made, byproducts being produced, raw materials being consumed, and utilities being used.

Questions like this tend to be very hard to answer using conventional systems due to various factors. For example, in some conventional systems, data for answering these questions is stored in different unconnected systems or simply absent. Also, personnel who might be associated with different data could be separated into different organizational units or “silos” and have little or no interaction with one another. However, the lack of answers to these types of questions can have a significant impact on the efficiency or effectiveness of a control and automation system.

In accordance with this disclosure, the system 100 supports the use of exploratory analytics 114, which denote analysis routines used for KPI analysis. Key performance indicators or “KPIs” denote performance metrics used by owners or operators of control and automation systems to track how their systems are operating against specified targets. KPIs can be defined for a number of functional and business-related objectives, such as operational efficiency, product quality, equipment reliability, and safety. KPIs can be measured repeatedly over time and compared against threshold values to determine how well an organization is meeting its KPI targets. KPIs can often be defined and used hierarchically, such as when primary KPIs define overall business objectives and secondary and tertiary KPIs are related to more specific aspects of a control and automation system. Various tools are known and used to define and calculate KPI values and compare the KPI values to threshold values, such as the INTUITION KPI product from HONEYWELL INTERNATIONAL INC.

The exploratory analytics 114 therefore support various analyses of data related to industrial equipment 104 at one or more sites 102a-102n. The exploratory analytics 114 can, among other things, analyze the KPI values and other data related to the industrial equipment 104. For example, the exploratory analytics 114 could support functions such as machine-learning techniques like clustering, classification, and regression. Clustering can involve revealing new groupings of data by calculating their similarity to other data. One example of a clustering technique that could be supported is “k-means” clustering. Classification can involve identifying to which of a set of known categories a new observation belongs. Examples of classification techniques that could be supported include single or multi-class classifications and decision trees. Regression can involve estimating quantitative relationships among variables. Examples of regression techniques that could be supported include linear and logistic regressions, principal component analysis (PCA) regression, and partial least squares (PLS) regression. The exploratory analytics 114 could support single variable analyses and multi-variable analyses, which denote analyses involving different numbers of variables for the related industrial equipment 104. The exploratory analytics 114 could also support drill-down analyses in which the results of one or more analyses are presented and, upon request, the results of additional related analyses can be presented. Example details of the types of analyses performed by the exploratory analytics 114 are provided below.

As shown in FIG. 1, the exploratory analytics 114 could be provided in various ways. For example, in some embodiments, the exploratory analytics 114 could be executed by one or more servers 118 or other standalone computing devices. Each server 118 could include one or more processing devices, one or more memories, and one or more interfaces. Each processing device includes any suitable processing or computing device, such as a microprocessor, microcontroller, digital signal processor, field programmable gate array, application specific integrated circuit, or discrete logic devices. Each memory includes any suitable storage and retrieval device, such as a RAM or other volatile memory or a Flash, ROM, or other non-volatile memory. Each interface includes any suitable structure facilitating communication over a connection or network, such as a wired interface (like an Ethernet interface) or a wireless interface (like a radio frequency transceiver).

Data associated with the one or more sites 102a-102n could be collected and stored in one or more databases 120 accessible by the server(s) 118. The collection of this data could occur in any suitable manner. For example, the various sites 102a-102n could be queried for this data, or the data could be collected and provided in a manual or automated manner from the sites 102a-102n at regular intervals or at other times. Each database 120 includes any suitable structure for storing and facilitating retrieval of information. Each database 120 could also support any suitable data structure and any suitable extraction mechanism (such as SQL or SAP).

In other embodiments, the exploratory analytics 114 could be executed within a network-based environment 122, such as a computing cloud. The network-based environment 122 could include various components that support network-based exploratory analytics. For example, the network-based environment 122 could include servers or other computing devices executing logic that analyzes data associated with the sites 102a-102n, as well as database servers or other computing devices for storing data used by the logic. As is typical with computing clouds, the specific device or devices executing the exploratory analytics 114 and storing the data can change over time, such as when different servers are selected at different times for executing the exploratory analytics 114 based on load balancing or other factors.

Note that the exploratory analytics 114 could be implemented in any other suitable manner. For example, the exploratory analytics 114 could be implemented on at least one computing device within one or more of the sites 102a-102n. Such an approach may be feasible when all sites 102a-102n are associated with the same organization (such as a single company). Such an approach may not be preferred when different sites 102a-102n are associated with different organizations, since one organization may not wish to analyze its competitor's data or provide its own data to a competitor.

Based on this, it is possible to provide the exploratory analytics 114 in different ways. For example, the exploratory analytics 114 could be provided as a web-based or cloud-based service to owners and operators of control and automation systems. In this approach, the data used by the exploratory analytics 114 can be collected from the sites 102a-102n and used by the exploratory analytics 114. The exploratory analytics 114 could also be provided as a product, such as when the exploratory analytics 114 are implemented as software that can be downloaded or otherwise provided to computing devices at or associated with the sites 102a-102n.

The analytics 114 are described here as “exploratory” in that they allow users to explore various aspects of their control and automation systems. “Predictive” analyses (used to predict faults or other problems) and “prescriptive” analyses (used to identify solutions to predicted problems) can be very useful in situations where problems are predefined and answers are completely contained in available data. Exploratory analyses typically combine a human user's expertise with automated data analytics to facilitate the user's ability to visualize trends and relationships among data in order to suggest follow-up investigations, but exploratory analyses may avoid attempting to identify specific solutions to predicted problems.

As described in more detail below, the exploratory analytics 114 can support an “open” approach or platform. For instance, the types of analyses to be performed by the exploratory analytics 114 depend at least partially on the data made available to the exploratory analytics 114. Users associated with various sites 102a-102n can therefore control the types of data collected and used by the exploratory analytics 114 and control the specific types of analyses performed by the exploratory analytics 114. Various data types and exploratory analytics 114 could also be predefined within the exploratory analytics 114 so that, for example, analyses common across multiple sites 102a-102n could be supported.

In this way, the exploratory analytics 114 effectively provide a diagnostic layer over traditional data collection and KPI calculations. Users are able to dive further into their data and identify correlations and other relationships between data from different systems and possibly from different sites. With a deeper understanding of how various aspects of their control and automation systems inter-relate, users may be able to more effectively configure, manage, and control their industrial processes.

Although FIG. 1 illustrates one example of a system 100 supporting exploratory analytics for KPI analysis, various changes may be made to FIG. 1. For example, the system 100 could include any number of sites, pieces of equipment, controllers, data sources, gateways, exploratory analytics, servers, databases, and network-based environments. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, systems such as this are highly configurable and can be configured in any suitable manner according to particular needs. In addition, FIG. 1 illustrates one example environment in which exploratory analytics can be used. This functionality can be used in any other suitable device or system.

FIG. 2 illustrates an example device 200 supporting exploratory analytics for KPI analysis according to this disclosure. The device 200 could, for example, be used to execute part or all of the exploratory analytics 114. As particular examples, the device 200 could represent the server 118 or one or more computing devices within the network-based environment 122. Note, however, that the exploratory analytics 114 could be implemented using any other suitable device(s).

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete logic devices.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a RAM or any other suitable volatile or non-volatile storage device(s). The persistent storage 214 may contain one or more components or devices supporting longer-term storage of data, such as a ROM, Flash memory, hard drive, or optical disc.

The communications unit 208 supports communications with other systems or devices. For example, the communications unit 208 could include a network interface card that facilitates communications over at least one Ethernet network. The communications unit 208 could also include a wireless transceiver facilitating communications over at least one wireless network. The communications unit 208 may support communications through any suitable physical or wireless communication link(s).

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

Although FIG. 2 illustrates one example of a device 200 supporting exploratory analytics for KPI analysis, various changes may be made to FIG. 2. For example, various components in FIG. 2 could be combined, further subdivided, or omitted and additional components could be added according to particular needs. Also, computing devices can come in a wide variety of configurations, and FIG. 2 does not limit this disclosure to any particular configuration of computing device.

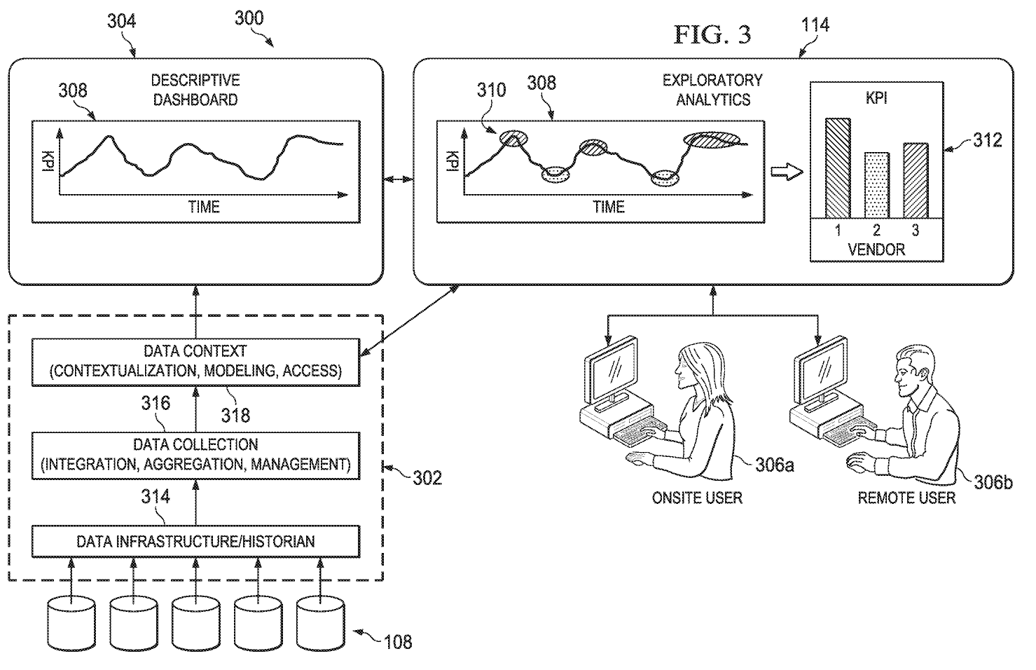

FIG. 3 illustrates an example technique 300 supporting exploratory analytics for KPI analysis according to this disclosure. The technique 300 described below could be supported by the device 200 of FIG. 2 operating as the server 118 or as part of the network-based environment 122 of FIG. 1. However, the technique 300 could be implemented using any suitable device(s) and in any suitable system.

As shown in FIG. 3, at least one data access system 302 obtains data from the one or more data sources 108. As described above, the data sources 108 could include sources such as process historians, operations management systems, alarm management systems, and maintenance systems. The data sources 108 could also include sources storing previous-calculated KPI data. Each data access system 302 accesses and retrieves data from at least one data source 108 upon request, in response to a triggering event, at a specified interval, or at any other suitable time(s). Each data access system 302 supports access to and retrieval of data from at least one data source 108. Any suitable data access system(s) 302 could be used here depending on the data source(s) 108 to be accessed.

The retrieved data can be processed as needed to generate at least one description dashboard 304. The dashboard 304 generates one or more graphical displays used to present KPI-related data to one or more users 306a-306b. For example, the dashboard 304 could generate one or more graphical displays 308 that plot different KPI values over time. The dashboard 304 includes any suitable logic for presenting graphical displays. In some embodiments, the dashboard 304 could be supported by the INTUITION EXECUTIVE product from HONEYWELL INTERNATIONAL INC.

While graphical displays 308 plotting KPI values over time can be useful, they may not provide much insight into the causes of KPI variations or relationships between or involving the KPIs. The exploratory analytics 114 can further analyze data, including the KPI data, to identify deeper or more useful information about industrial equipment 104 at one or more sites 102a-102n. For example, as shown in FIG. 3, the exploratory analytics 114 could isolate portions 310 of the KPI values, where the isolated portions 310 identify locally high and locally low KPI values over time. The exploratory analytics 114 could also generate a graphical display 312 showing the relationships between different raw material vendors and the KPI values within the isolated portions 310. Using such an approach, a user 306a or 306b could learn that the KPI value is higher or lower when raw material from a specific vendor is used. This may be much more valuable information than merely the ability to see when the KPI value reaches a local maximum value or a local minimum value.

Multiple types of users 306a-306b are shown in FIG. 3. The users 306a denote local users that are present at one or more sites 102a-102n, while the users 306b denote remote users that are outside of the sites 102a-102n. The ability for both local and remote users 306a-306b to access and use the exploratory analytics 114 may allow more effective collaboration between personnel, whether or not all personnel are associated with the same organization. Of course, this need not be the case, and only one type of user could be supported in a particular system.

In this example, the data access system 302 is formed using various functional components. The functional components include a data infrastructure or historian 314, which receives the data from the various data sources 108 and stores the data for further processing. A data collector 316 performs operations related to integrating, aggregating, and maintaining the data stored in the data infrastructure or historian 314. A data contextualizer 318 processes the integrated or aggregated data to support functions like contextualization, modeling, and data access. Each of these functions can be implemented within a data access system 302 using known or later-developed information management or information processing techniques.

Although FIG. 3 illustrates one example of a technique 300 supporting exploratory analytics for KPI analysis, various changes may be made to FIG. 3. For example, the technique 300 could involve any number of data sources 108 and any number of data access systems 302. Also, data from the data source(s) 108 could be obtained in other ways without using a data access system. In addition, FIG. 3 shows the identification of KPI data and then the use of exploratory analytics 114. However, this is for illustration only. The calculation of KPI data could form part of or occur in parallel with the exploratory analytics 114.

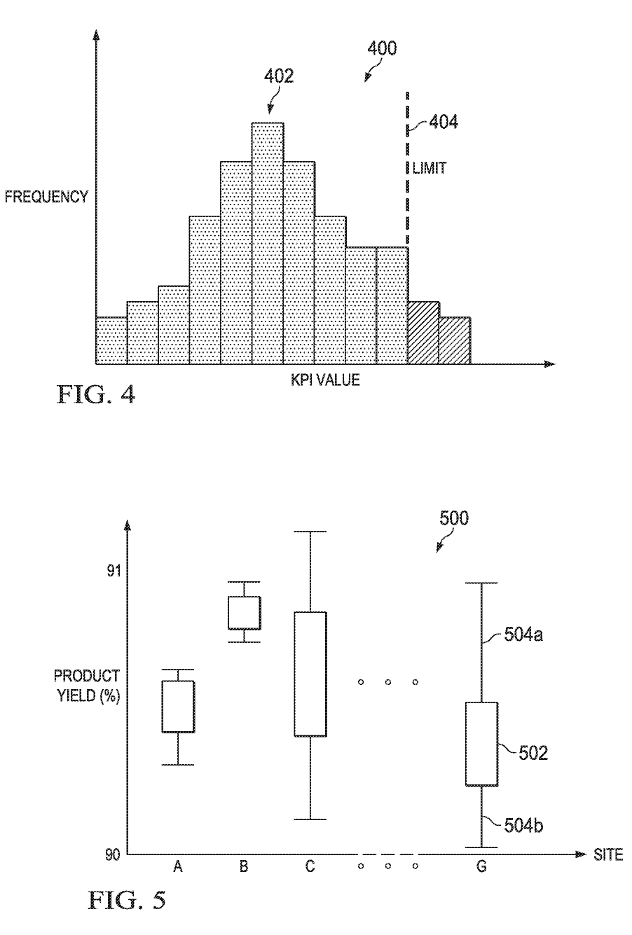

FIGS. 4 through 11 illustrate example graphical displays based on exploratory analytics for KPI analysis according to this disclosure. For ease of explanation, the graphical displays described below could be generated by the device 200 of FIG. 2 operating as the server 118 or as part of the network-based environment 122 of FIG. 1. However, the graphical displays could be generated using any suitable device(s) and in any suitable system.

As noted above, the exploratory analytics 114 can support various single variable analyses. Single variable analyses typically focus on analyzing data to identify things like how a specific variable behaves, when a specific variable deviates from an expected or desired value or pattern, how often a specific variable deviates from an expected or desired value or pattern, and by how much a specific variable deviates from an expected or desired value or pattern. The exploratory analytics 114 can analyze suitable data for each variable to make such determinations as needed or desired. The exploratory analytics 114 can also generate graphical displays containing the results of the single variable analyses.

FIG. 4 illustrates an example graphical display 400 for a single variable analysis. As shown in FIG. 4, the graphical display 400 plots (in histogram form) the frequencies at which a particular KPI obtains different values. The graphical display 400 includes multiple bars 402, each of which is associated with a different value of the KPI and identifies the frequency or number of times that KPI value is obtained in a given time period. The graphical display 400 also includes a line 404 denoting a limit (in this case an upper limit) placed on that particular KPI. Using this type of graphical display 400, a user could see that the value of the KPI tends to more frequently lie around mid-point values but does occasionally violate its limit. In this example, the limit is violated around 17-20% of the time. Note that the plotting of a KPI's values against the frequency of those values is one example of a single variable analysis and that any other suitable single variable analyses could be performed. Also note that a lower limit or more than one limit could be identified in the graphical display 400.

FIG. 5 illustrates another example graphical display 500 for a single variable analysis. As shown in FIG. 5, the graphical display 500 plots (in “box and whisker” form) the yield percentage for a product being manufactured or processed at different sites. Each site is associated with a box 502, which is centered on the median yield percentage for that site and extends from the upper quartile for the yield percentage to the lower quartile for the yield percentage. Each box 502 is connected to two whiskers 504a-504b. The whisker 504a extends from the box 502 to the highest extreme value of the yield percentage, while the whisker 504b extends from the box 502 to the lowest extreme value of the yield percentage. Using this type of graphical display 500, a user could see that some sites (namely sites A and B) have smaller boxes 502 and shorter whiskers 504a-504b, indicating that the yield percentages at those sites have less variability that at other sites (namely sites C and G). The user could also see that one site (namely site B) has consistently higher product yields with less variability that the other sites. Note that the plotting of a product's yield percentage against sites is another example of a single variable analysis and that any other suitable single variable analyses could be performed.

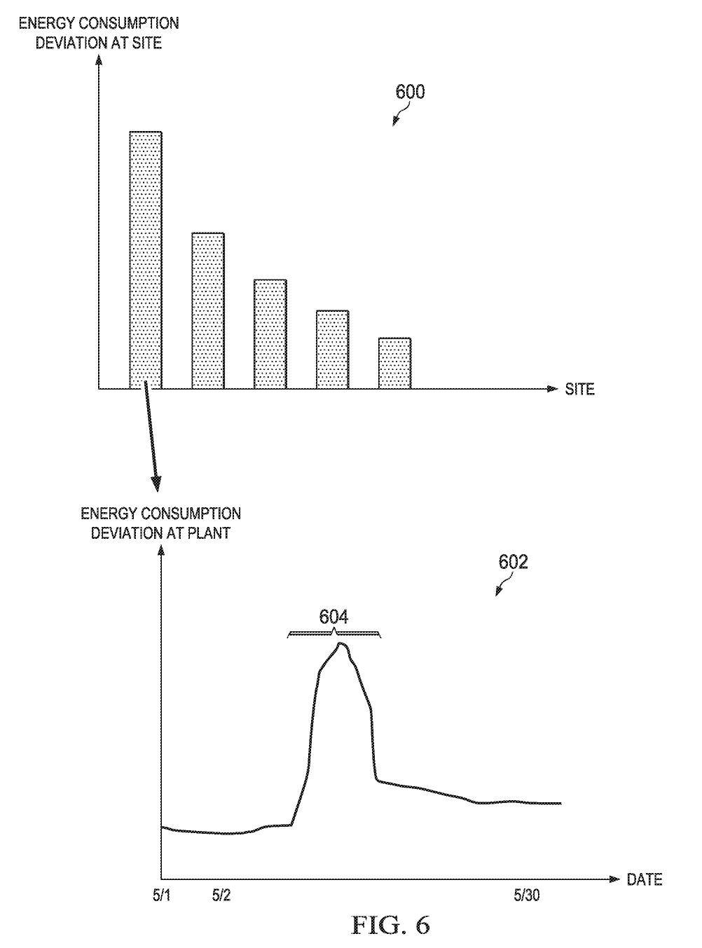

Drill-down analyses are also supported by the exploratory analytics 114. In drill-down analyses, the results of one or more analyses are presented and, upon request, the results of additional analyses can be presented. This process could occur once or more than once to support any number of desired analysis levels. FIG. 6 illustrates an example in which a graphical display 600 containing a single variable analysis is used to obtain another graphical display 602 containing an additional analysis. In FIG. 6, the graphical display 600 identifies the deviation in energy consumption at different sites for a given time period (such as a one-month period). Upon selection of the bar or other identifier associated with the first site, the graphical display 602 can be presented, where energy consumption deviations from a target value for the first site are plotted over time. The user is therefore able to identify that something happened at the first site during a time period 604 that significantly increased energy consumption. Note that the plotting of energy deviation against site or time is one example of a drill-down analysis and that any other suitable drill-down analyses could be performed. For instance, the graphical display 600 could present the energy consumption deviation for equipment within a single site, and the graphical display 602 could present the energy consumption deviation for a selected piece of equipment in that single site.

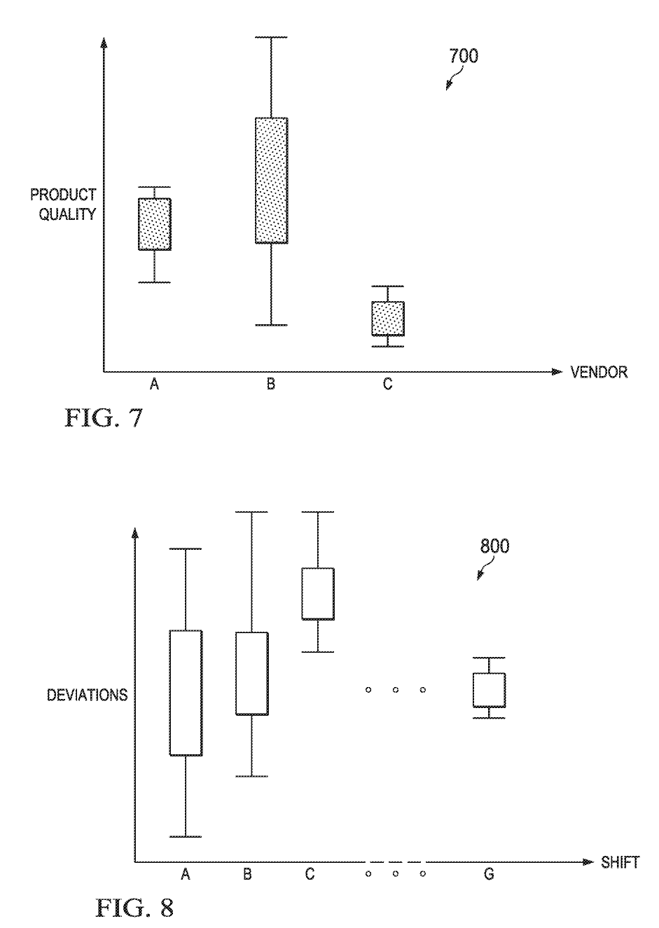

FIGS. 7 through 9 illustrate example graphical displays for different multi-variable analyses. For example, FIG. 7 illustrates an example graphical display 700 for a multi-variable analysis involving the vendors supplying at least one raw material and the product qualities of an end product produced using the raw material(s). As shown in FIG. 7, the graphical display 700 plots the vendors against the product qualities in “box and whisker” form. As can be seen in FIG. 7, one vendor (namely vendor C) is associated with consistently lower product quality.

FIG. 8 illustrates an example graphical display 800 for a multi-variable analysis involving the work shifts for personnel at a site and deviations in product quality, product yield, or other variable. As shown in FIG. 8, the graphical display 800 plots the work shifts versus deviations in “box and whisker” form. As can be seen in FIG. 8, one work shift (namely shift C) is associated with consistently higher deviations in product quality or product yield.

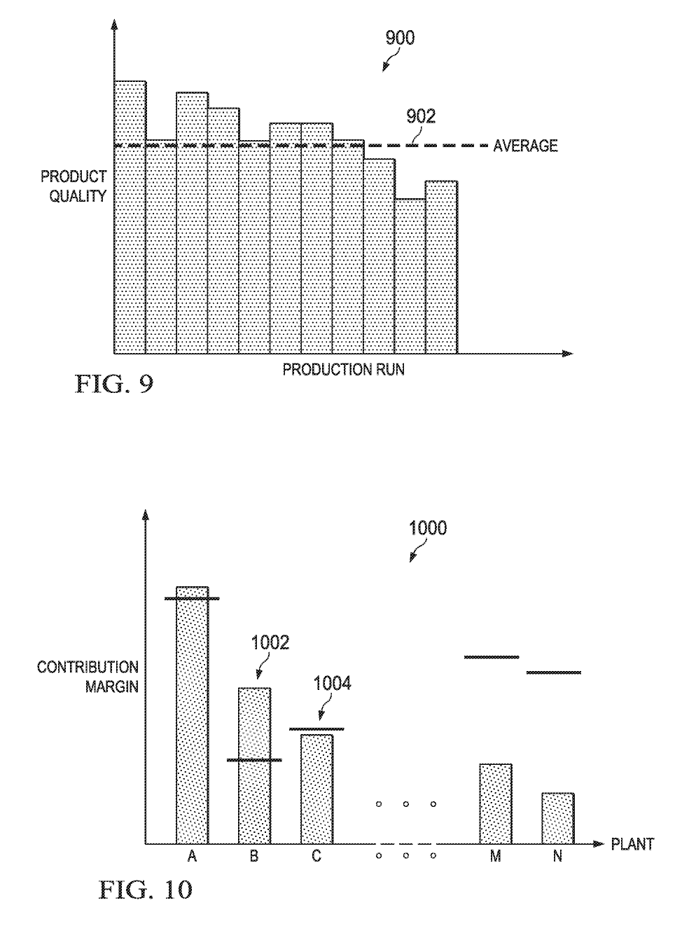

FIG. 9 illustrates an example graphical display 900 for a multi-variable analysis involving the production runs of a product and the product qualities during those runs. As shown in FIG. 9, the graphical display 900 plots the production runs versus product qualities in bar graph form, along with a line 902 denoting the average product quality across all production runs. As can be seen in FIG. 9, the production runs started with higher-than-average product quality, but the product quality has been gradually declining over time. Note that these represent examples of multi-variable analyses and that any other suitable multi-variable analyses could be performed.

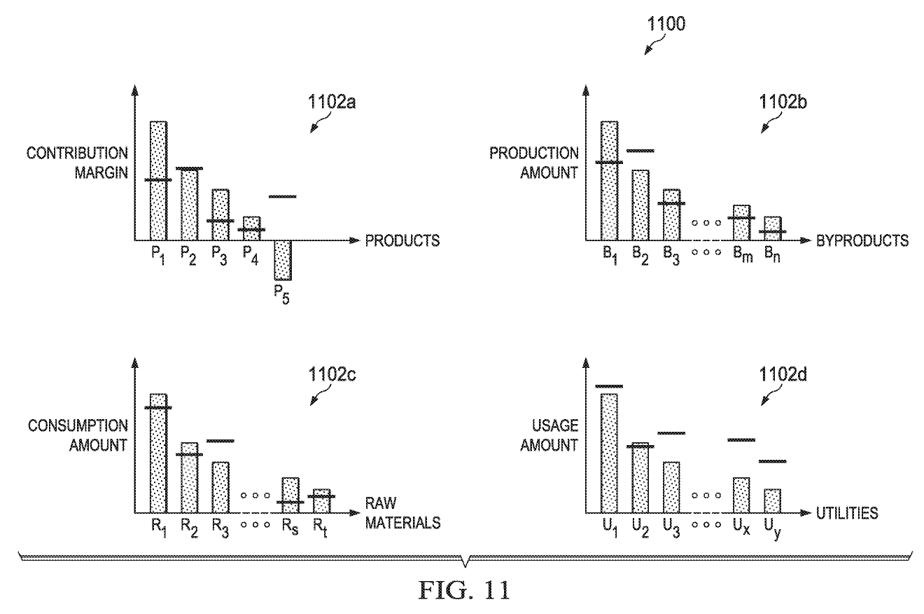

FIGS. 10 and 11 illustrate an example graphical display supporting another drill-down analysis with multiple multi-variable analyses performed. As shown in FIG. 10, a graphical display 1000 identifies the overall contribution margin of different equipment or areas in a plant. The contribution margin values identify the relative profitability of the different equipment or areas of the plant. The graphical display 1000 includes bars 1002 identifying the contribution margins and indicators 1004 identifying the desired or target contribution margins for the different equipment or areas of the plant.

Selection of one of the different equipment or areas of the plant in FIG. 10 can present a graphical display 1100 as shown in FIG. 11. The graphical display 1100 includes different sub-displays 1102a-1102d each associated with a different multi-variable analysis for the selected equipment or area of the plant. In particular, the sub-display 1102a includes a graphical display plotting contribution margins for different products manufactured or processed using the selected equipment or area of the plant. The sub-display 1102b includes a graphical display plotting production amounts of different byproducts manufactured or processed using the selected equipment or area of the plant. The sub-display 1102c includes a graphical display plotting consumption amounts of different raw materials by the selected equipment or area of the plant. The sub-display 1102d includes a graphical display plotting usage amounts of different utilities by the selected equipment or area of the plant. Each of these graphical displays also includes indicators identifying the desired or target contribution margins, production amounts, consumption amounts, or usage amounts for the different products, byproducts, raw materials, or utilities. The drill-down analysis shown in FIGS. 10 and 11 may allow a user to select particular equipment or a particular area of a plant to view why the contribution margin for that equipment or area is above or below a target value.

Note that the plotting of contribution margins, production amounts, consumption amounts, and usage amounts are examples of a drill-down analysis and that any other suitable drill-down analyses could be performed. For instance, the graphical display 1000 could present the contribution margins for different sites, and the graphical display 1100 could present the contribution margins, production amounts, consumption amounts, and usage amounts for a selected site.

The contents in each of FIGS. 4 through 11 can be generated by the exploratory analytics 114 in any suitable manner. For example, a user could determine that a particular analysis is needed or desired for specific industrial equipment, plants, or sites and that such an analysis requires one or more specified types of data. The user can configure one or more data access systems 302 to retrieve the data necessary for the particular analysis from one or more data sources 108. If multiple data sources 108 are used, the data sources 108 could denote related data sources or completely separate data sources having no normal interactions. The data access systems 302 can retrieve the specified types of data from the data sources 108 and provide the retrieved data to the exploratory analytics 114 for analysis. The data could first be analyzed to calculate KPI values, either by a separate tool or by the exploratory analytics 114. The analysis performed by the exploratory analytics 114 includes the particular analysis defined by the user. The results of the analysis can then be made available to the same user or to one or more different users. As noted above, a particular analysis could also be predefined in the system 100, such as when certain analyses are known or likely to be needed by multiple users. In that case, a user may not be required to configure the data access systems 302 or define the analysis to be performed.

Although FIGS. 4 through 11 illustrate examples of graphical displays based on exploratory analytics for KPI analysis, various changes may be made to FIGS. 4 through 11. For example, the graphical displays shown in FIGS. 4 through 11 merely show results of example types of analyses that could be performed by the exploratory analytics 114. The exploratory analytics 114 could perform any other or additional types of analyses as needed or desired. Also, the forms of the graphical displays shown in FIGS. 4 through 11 (such as histogram, box and whisker, and bar plots) are examples only. Any other or additional types of graphical displays could be generated to display results of one or more analyses.

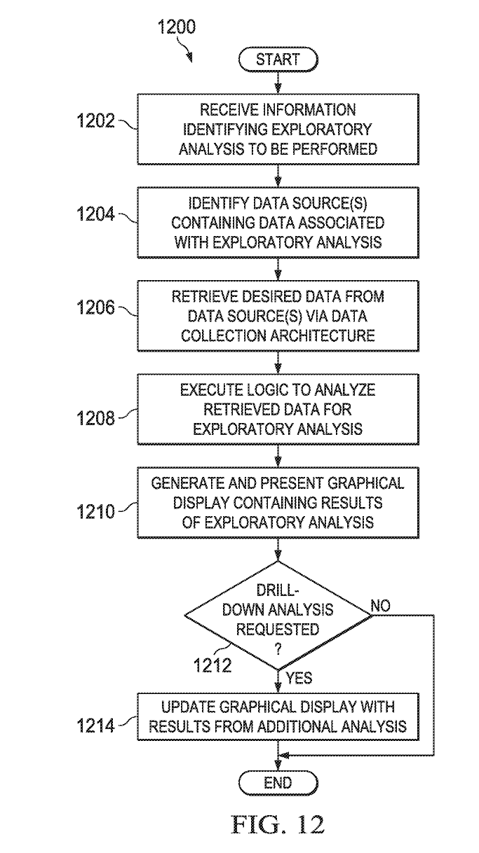

FIG. 12 illustrates an example method 1200 supporting exploratory analytics for KPI analysis according to this disclosure. For ease of explanation, the method 1200 described below could be performed at least partially by the device 200 of FIG. 2 operating as the server 118 or as part of the network-based environment 122 of FIG. 1. However, the method 1200 could be performed using any suitable device(s) and in any suitable system.

As shown in FIG. 12, information identifying an exploratory analysis to be performed is received at step 1202. This could include, for example, the processing device 204 of the device 200 receiving user input identifying one or more exploratory analytics 114 to be executed. The exploratory analytics 114 to be executed could include one or more predefined analysis routines or one or more custom analysis routines defined by the user.

One or more data sources containing data associated with the requested exploratory analysis are identified at step 1204. This could include, for example, the processing device 204 of the device 200 receiving user input identifying the data source(s) 108 containing data to be retrieved and the type(s) of data to be retrieved from each data source 108. This could also include the processing device 204 of the device 200 using other information, such as data mappings or other information associated with predefined exploratory analysis routines, to automatically identify the data source(s) 108.

This could further include the processing device 204 of the device 200 using a data schema (such as a predefined, inherited, or user-defined schema) to identify how specific data is to be retrieved. As a particular example, if data is being obtained to identify whether specific equipment has failed, a data schema could define that outage data from a process historian is to be combined with work-order data from a maintenance system. In some embodiments, a data schema could be inherited from another device or system, such as from the PI ASSET FRAMEWORK product from OSISOFT, LLC.

Desired data is retrieved from the data source(s) using a data collection architecture at step 1206. This could include, for example, the processing device 204 of the device 200 executing or interacting with one or more data access systems 302 to obtain the desired information. This could also include the processing device 204 of the device 200 using the data schema discussed above to obtain the appropriate data.

Logic is executed to analyze the retrieved data and implement the requested exploratory analysis at step 1208. This could include, for example, the processing device 204 of the device 200 executing instructions for analyzing the retrieved data to provide the desired analysis. As noted above, the types of analyses can vary widely. Some analyses could be performed using predefined logic, while other analyses could be performed using user-defined logic. The analyses could also include different types of analyses, such as single variable analyses, multi-variable analyses, or drill-down analyses.

A graphical display containing the results of the requested exploratory analysis is generated and presented at step 1210. This could include, for example, the processing device 204 of the device 200 generating a graphical display containing one or more histograms, box-and-whisker plots, bar charts, or other graphical data. The graphical display could form part of a dashboard or other larger user interface.

If drill-down analysis is requested at step 1212, the graphical display is updated with results from at least one additional exploratory analysis at step 1214. This could include, for example, the processing device 204 of the device 200 receiving a selection of a particular site, equipment, plant area, vendor, work shift, or other option in the original graphical display. This could also include the processing device 204 of the device 200 obtaining additional data and executing additional logic to identify results of one or more additional analyses related to the selected site, equipment, plant area, vendor, work shift, or other option.

Although FIG. 12 illustrates one example of a method 1200 supporting exploratory analytics for KPI analysis, various changes may be made to FIG. 12. For example, while shown as a series of steps, various steps in FIG. 12 could overlap, occur in parallel, occur in a different order, or occur any number of times.

As a particular example, the additional analysis or analyses performed as part of the drill-down in step 1214 could be executed earlier, and the results of the additional analysis or analyses could be presented at step 1214. As another example, steps 1212-1214 could be omitted, such as in situations where the user does not request execution of a drill-down analysis.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying to that any particular element, step, or function is an essential or critical element that must be included in the claim scope. The scope of patented subject matter is defined only by the allowed claims. Moreover, none of the claims invokes 35 U.S.C. §110(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §110(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving information associated with industrial equipment from multiple data sources, the information comprising different types of information related to the industrial equipment and received from at least two different types of data sources;
executing exploratory analysis routines using at least some of the received information; and
generating one or more displays identifying results of the exploratory analysis routines;
wherein at least one of the exploratory analysis routines uses key performance indicator (KPI) data associated with the industrial equipment; and
wherein at least one of the exploratory analysis routines includes logic defined by at least one user associated with the industrial equipment and uses data that is retrieved based on input from the at least one user.

2. The method of claim 1, wherein the receiving, executing, and generating are performed by a web-based platform or a cloud-based platform.

3. The method of claim 1, wherein:
at least one of the exploratory analysis routines includes a single-variable analysis; and
the display associated with the single-variable analysis presents results based on a single variable associated with the industrial equipment.

4. The method of claim 1, wherein:
at least one of the exploratory analysis routines includes a multi-variable analysis; and
the display associated with the multi-variable analysis presents results based on multiple variables associated with the industrial equipment.

5. The method of claim 1, wherein:
at least one of the exploratory analysis routines includes a drill-down analysis;
a first of the displays presents results of a first of the exploratory analysis routines associated with the drill-down analysis; and
upon selection of an option in the first display, a second of the displays presents results of a second of the exploratory analysis routines associated with the drill-down analysis, the second exploratory analysis routine based on the selected option in the first display.

6. The method of claim 5, wherein the second display includes results from multiple second exploratory analysis routines, the second exploratory analysis routines based on different variables associated with the selected option in the first display.

7. The method of claim 1, wherein the input from the at least one user comprises input defining a data schema identifying how specific data is to be retrieved from one or more of the data sources.

8. The method of claim 1, further comprising inheriting a data schema identifying how specific data is to be retrieved from one or more of the data sources.

9. The method of claim 1, wherein at least one of the exploratory analysis routines uses at least one machine-learning technique, the at least one machine-learning technique comprising one or more of: clustering, classification, and regression.

10. A system comprising:
at least one interface configured to receive information associated with industrial equipment from multiple data sources, the information comprising different types of information related to the industrial equipment and received from at least two different types of data sources; and
at least one processing device configured to:
execute exploratory analysis routines using at least some of the received information; and
generate one or more displays identifying results of the exploratory analysis routines;
wherein at least one of the exploratory analysis routines uses key performance indicator (KPI) data associated with the industrial equipment; and
wherein at least one of the exploratory analysis routines includes logic defined by at least one user associated with the industrial equipment and uses data that is retrieved based on input from the at least one user.

11. The system of claim 10, wherein:
at least one of the exploratory analysis routines includes a single-variable analysis; and
the display associated with the single-variable analysis presents results based on a single variable associated with the industrial equipment.

12. The system of claim 10, wherein:
at least one of the exploratory analysis routines includes a multi-variable analysis; and
the display associated with the multi-variable analysis presents results based on multiple variables associated with the industrial equipment.

13. The system of claim 10, wherein:
at least one of the exploratory analysis routines includes a drill-down analysis;
a first of the displays presents results of a first of the exploratory analysis routines associated with the drill-down analysis; and
upon selection of an option in the first display, a second of the displays presents results of a second of the exploratory analysis routines associated with the drill-down analysis, the second exploratory analysis routine based on the selected option in the first display.

14. The system of claim 13, wherein the second display includes results from multiple second exploratory analysis routines, the second exploratory analysis routines based on different variables associated with the selected option in the first display.

15. The system of claim 10, wherein a data schema identifying how specific data is to be retrieved from one or more of the data sources is one of:
based on the input from the at least one user; and
inherited.

16. The system of claim 10, wherein the at least one interface and the at least one processing device form a portion of a web-based platform or a cloud-based platform.

17. A non-transitory computer readable medium containing computer readable program code that when executed causes at least one processing device to:
receive information associated with industrial equipment from multiple data sources, the information comprising different types of information related to the industrial equipment and received from at least two different types of data sources; and
execute exploratory analysis routines using at least some of the received information; and
generate one or more displays identifying results of the exploratory analysis routines;
wherein at least one of the exploratory analysis routines uses key performance indicator (KPI) data associated with the industrial equipment; and
wherein at least one of the exploratory analysis routines includes logic defined by at least one user associated with the industrial equipment and uses data that is retrieved based on input from the at least one user.

18. The non-transitory computer readable medium of claim 17, wherein:
at least one of the exploratory analysis routines includes a single-variable analysis; and
the display associated with the single-variable analysis presents results based on a single variable associated with the industrial equipment.

19. The non-transitory computer readable medium of claim 17, wherein:
at least one of the exploratory analysis routines includes a multi-variable analysis; and
the display associated with the multi-variable analysis presents results based on multiple variables associated with the industrial equipment.

20. The non-transitory computer readable medium of claim 17, wherein:
at least one of the exploratory analysis routines includes a drill-down analysis;
a first of the displays presents results of a first of the exploratory analysis routines associated with the drill-down analysis; and
upon selection of an option in the first display, a second of the displays presents results of a second of the exploratory analysis routines associated with the drill-down analysis, the second exploratory analysis routine based on the selected option in the first display.

21. The non-transitory computer readable medium of claim 20, wherein the second display includes results from multiple second exploratory analysis routines, the second exploratory analysis routines based on different variables associated with the selected option in the first display.

22. The non-transitory computer readable medium of claim 17, wherein the data sources include at least two of:
a process historian;
an operations management system;
an alarm management system; and
a maintenance system.
